(19) United States
(12) Patent Application Publication
(10) Pub. No.: US 2025/0203327 A1
(43) Pub. Date: Jun. 19, 2025

(54) IMAGE LOCALIZATION WITHIN AN ENVIRONMENT

(71) Applicant: Open Space Labs, Inc., San Francisco, CA (US)

(72) Inventors: Michael Ben Fleischman, Sonoma, CA (US); Philip DeCamp, Boulder, CO (US); Gabriel Hein, Albany, CA (US); Peter Cassidy Horak, Somerville, MA (US); Denis Girard, Miami Beach, FL (US)

(21) Appl. No.: 18/977,851

(22) Filed: Dec. 11, 2024

Related U.S. Application Data
(60) Provisional application No. 63/609,877, filed on Dec. 14, 2023.

(51) Int. Cl. H04W 4/33; H04W 4/02; H04W 4/38

(52) U.S. Cl. CPC H04W 4/33; H04W 4/027; H04W 4/38

(57) ABSTRACT

A system maintains an IPS index. The IPS index includes magnetic fingerprints, each associated with a different time of capture, and each including magnetic fingerprint data of locations within a building. The system receives an image and associated magnetic data captured at a location within the building. The system selects a magnetic fingerprint from the IPS Index associated with a time within some time window of the time of capture of the received image. The system queries the selected magnetic fingerprint with the magnetic data associated with the received image to identify a location within the building corresponding to the magnetic data. The system localizes the received image based on the identified location.

### CROSS REFERENCE TO RELATED APPLICATIONS

This application claims the benefit of U.S. Provisional Application Ser. No. 63/609,877 filed Dec. 14, 2023, which are incorporated in its entirety herein by this reference.

### TECHNICAL FIELD

This disclosure relates to localizing images within an environment based on magnetic fingerprint data.

### BACKGROUND

Images provide a convenient method for reviewing details of an environment without physically being present. For instance, contractors may monitor progress on construction sites using the images taken at the construction sites. However, monitoring the construction sites using the images presents several challenges. Accurate localization of the images within construction sites is difficult due to a lack of GPS signals, hindering the ability to pinpoint precise locations where the images were captured. Additionally, the dynamic nature of the construction sites leads to constant changes in building interiors, complicating the comparison of the images obtained at different times.

Construction sites present additional challenges when trying to establish stable magnetic fingerprints for localization, as several factors such as concrete, steel, walls, and electrical systems can alter the magnetic fingerprints. Furthermore, traditional indoor positioning systems (IPS), which rely on Bluetooth beacons or Wi-Fi access points, often struggle to address the unique obstacles posed by complex, constantly evolving environments like the construction sites.

### SUMMARY

A system maintains an IPS index. The IPS index includes magnetic fingerprints, each associated with a different time of capture, and each including magnetic fingerprint data of locations within a building. The system receives an image and associated magnetic data captured at a location within the building. The system selects a magnetic fingerprint from the IPS index associated with a time within some time window of the time of capture of the received image. The system queries the selected magnetic fingerprint with the magnetic data associated with the received image to identify a location within the building corresponding to the magnetic data. The system localizes the received image based on the identified location.

In yet another embodiment, a system captures magnetic fingerprint data during each of a plurality of walkthroughs of a building at each of a plurality of times during construction of the building. The system generates an IPS index associated with the building based on the captured magnetic fingerprint data. The IPS associates captured magnetic fingerprint data with locations within the building. The system receives real-time magnetic fingerprint data captured by a device within the building. The system queries the IPS using the real-time magnetic fingerprint data to produce an associated location. The system localizes the device within the building based on the associated location.

In yet another embodiment, a system captures magnetic fingerprint data during each of a plurality of walkthroughs of a building at each of a plurality of times during construction of the building. The system generates an IPS index associated with the building based on the captured magnetic fingerprint data. The IPS associates captured magnetic fingerprint data with locations within the building. The system tracks a location of a device of a user through the building using an inertial measurement unit (IMU) of the device. To avoid IMU drift, the device captures magnetic fingerprint data by the device. The system queries the IPS using the first magnetic fingerprint data to produce an associated location. The system updates the tracked location of the device using the associated location.

### BRIEF DESCRIPTION OF THE DRAWINGS

FIG. 1 illustrates a system environment for indoor positioning, according to one embodiment.

FIG. 2A illustrates a block diagram of a path module, according to one embodiment.

FIG. 2B illustrates a block diagram of a model generation module, according to one embodiment.

FIG. 3 is a flow chart illustrating an example method for localizing an image within an environment based on magnetic fingerprint data, according to one embodiment.

FIG. 4 is a flow chart illustrating an example method for localizing a device within a building, according to one embodiment.

FIG. 5 is a flow chart illustrating an example method for tracking a location of a device within a building, according to one embodiment.

FIG. 6 is a diagram illustrating a computer system that implements the embodiments herein, according to one embodiment.

### DETAILED DESCRIPTION

### I. System Environment

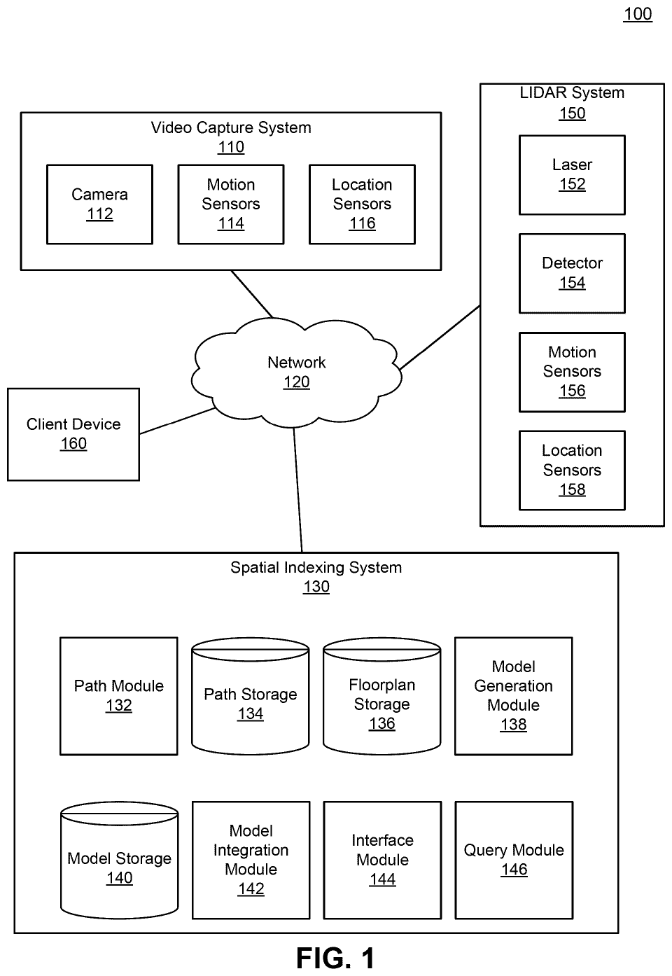

FIG. 1 illustrates a system environment 100 for an IPS system, according to one embodiment. In the embodiment shown in FIG. 1, the system environment 100 includes a video capture system 110, a network 120, a spatial indexing system 130, a LIDAR system 150, and a client device 160. Although a single video capture system 110, a single LIDAR system 150, and a single client device 160 is shown in FIG. 1, in some implementations the spatial indexing system 130 interacts with multiple video capture systems 110, multiple LIDAR systems 150, and/or multiple client devices 160.

The video capture system 110 collects one or more of frame data, motion data, and location data as the video capture system 110 is moved along a path. In the embodiment shown in FIG. 1, the video capture system 110 includes a camera 112, motion sensors 114, and location sensors 116. The video capture system 110 is implemented as a device with a form factor that is suitable for being moved along the path. In one embodiment, the video capture system 110 is a portable device that a user physically moves along the path, such as a wheeled cart or a device that is mounted on or integrated into an object that is worn on the user's body (e.g., a backpack or hardhat). In another embodiment, the video capture system 110 is mounted on or integrated into a vehicle. The vehicle may be, for example, a wheeled vehicle (e.g., a wheeled robot) or an aircraft (e.g., a quadcopter drone), and can be configured to autonomously travel along a preconfigured route or be controlled by a human user in real-time. In some embodiments, the video capture system 110 is a part of a mobile computing device such as a smartphone, tablet computer, or laptop computer. The video capture system 110 may be carried by a user and used to capture a video as the user moves through the environment along the path.

The camera 112 collects videos including a sequence of image frames as the video capture system 110 is moved along the path. In some embodiments, the camera 112 is a 360-degree camera that captures 360-degree frames. The camera 112 can be implemented by arranging multiple non-360-degree cameras in the video capture system 110 so that they are pointed at varying angles relative to each other, and configuring the multiple non-360 cameras to capture frames of the environment from their respective angles at approximately the same time. The image frames can then be combined to form a single 360-degree frame. For example, the camera 112 can be implemented by capturing frames at substantially the same time from two 180° panoramic cameras that are pointed in opposite directions. In other embodiments, the camera 112 has a narrow field of view and is configured to capture typical 2D images instead of 360-degree frames.

The frame data captured by the video capture system 110 may further include frame timestamps. The frame timestamps are data corresponding to the time at which each frame was captured by the video capture system 110. As used herein, frames are captured at substantially the same time if they are captured within a threshold time interval of each other (e.g., within 1 second, within 100 milliseconds, etc.).

In one embodiment, the camera 112 captures a walkthrough video as the video capture system 110 is moved throughout the environment. The walkthrough video including a sequence of image frames that can be captured at any frame rate, such as a high frame rate (e.g., 60 frames per second) or a low frame rate (e.g., 1 frame per second). In general, capturing the sequence of image frames at a higher frame rate produces more robust results, while capturing the sequence of image frames at a lower frame rate allows for reduced data storage and transmission. In another embodiment, the camera 112 captures a sequence of still frames separated by fixed time intervals. In yet another embodiment, the camera 112 captures single image frames. The motion sensors 114 and location sensors 116 collect motion data and location data, respectively, while the camera 112 is capturing the frame data. The motion sensors 114 can include, for example, an accelerometer and a gyroscope. The motion sensors 114 can also include a magnetometer that measures a direction of a magnetic field surrounding the video capture system 110.

The location sensors 116 can include a receiver for a global navigation satellite system (e.g., a GPS receiver) that determines the latitude and longitude coordinates of the video capture system 110. In some embodiments, the location sensors 116 additionally or alternatively include a receiver for an indoor positioning system (IPS) that determines the position of the video capture system based on signals received from transmitters placed at known locations in the environment. For example, multiple radio frequency (RF) transmitters that transmit RF fingerprints are placed throughout the environment, and the location sensors 116 also include a receiver that detects RF fingerprints and estimates the location of the video capture system 110 within the environment based on the relative intensities of the RF fingerprints. In some embodiments, the location sensors 116 may include a magnetometer sensor that measures the Earth's geomagnetic field.

Although the video capture system 110 shown in FIG. 1 includes a camera 112, motion sensors 114, and location sensors 116, some of the components 112, 114, 116 may be omitted from the video capture system 110 in other embodiments. For instance, one or both of the motion sensors 114 and the location sensors 116 may be omitted from the video capture system.

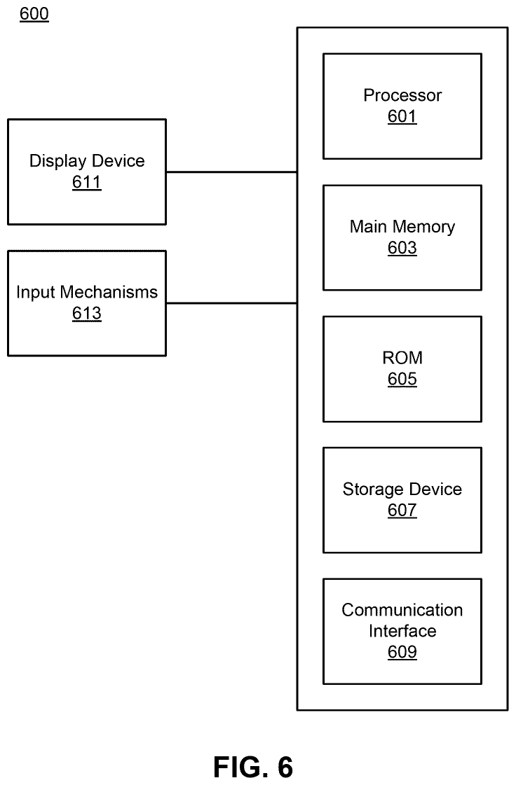

In some embodiments, the video capture system 110 is implemented as part of a computing device (e.g., the computer system 600 shown in FIG. 6) that also includes a storage device to store the captured data and a communication interface that sends the captured data over the network 120 to the spatial indexing system 130. In one embodiment, the video capture system 110 stores the captured data locally as the video capture system 110 is moved along the path, and the data is sent to the spatial indexing system 130 after the data collection has been completed. In another embodiment, the video capture system 110 sends the captured data to the spatial indexing system 130 in real-time as the system 110 is being moved along the path.

The video capture system 110 communicates with other systems over the network 120. The network 120 may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). The network 120 may also be used to deliver push notifications through various push notification services, such as APPLE Push Notification Service (APNs) and GOOGLE Cloud Messaging (GCM). Data exchanged over the network 110 may be represented using any suitable format, such as hypertext markup language (HTML), extensible markup language (XML), or JavaScript object notation (JSON). In some embodiments, all or some of the communication links of the network 120 may be encrypted using any suitable technique or techniques.

The light detection and ranging (LIDAR) system 150 collects three dimensional data representing the environment using a laser 152 and a detector 154 as the LIDAR system 150 is moved throughout the environment. The laser 152 emits laser pulses, and the detector 154 detects when the laser pulses return to the LIDAR system 150 after being reflected by a plurality of points on objects or surfaces in the environment. The LIDAR system 150 also includes motion sensors 156 and location sensors 158 that indicates the motion and the position of the LIDAR system 150 which can be used to determine the direction in which the laser pulses are emitted. The LIDAR system 150 generates LIDAR data associated with detected laser pulses after being reflected off surfaces of the objects or surfaces in the environment. The LIDAR data may include a set of (x,y,z) coordinates determined based on known direction in which the laser pulses were emitted and duration of time between emission by the laser 152 and detection by the detector 154. The LIDAR data may also include other attribute data such as intensity of detected laser pulse. In other embodiments, the LIDAR system 150 may be replaced by another depth-sensing system. Examples of depth-sensing systems include radar systems, 3D camera systems, and the like.

In some embodiments, the LIDAR system 150 is integrated with the video capture system 110. For example, the LIDAR system 150 and the video capture system 110 may be components of a smartphone that is configured to capture videos and LIDAR data. The video capture system 110 and the LIDAR system 150 may be operated simultaneously such that the video capture system 110 captures the video of the environment while the LIDAR system 150 collects LIDAR data. When the video capture system 110 and the LIDAR system 150 are integrated, the motion sensors 114 may be the same as the motion sensors 156 and the location sensors 116 may be the same as the location sensors 158. The LIDAR system 150 and the video capture system 110 may be aligned, and points in the LIDAR data may be mapped to a pixel in the image frame that was captured at the same time as the points such that the points are associated with image data (e.g., RGB values). The LIDAR system 150 may also collect timestamps associated with points. Accordingly, image frames and LIDAR data may be associated with each other based on timestamps. As used herein, a timestamp for LIDAR data may correspond to a time at which a laser pulse was emitted toward point or a time at which the laser pulse was detected by the detector 154. That is, for a timestamp associated with an image frame indicating a time at which the image frame was captured, one or more points in the LIDAR data may be associated with the same timestamp. In some embodiments, the LIDAR system 150 may be used while the video capture system 110 is not being used, and vice versa. In some embodiments, the LIDAR system 150 is a separate system from the video capture system 110. In such embodiments, the path of the video capture system 110 may be different from the path of the LIDAR system 150.

The spatial indexing system 130 receives the image frames captured by the video capture system 110 and the LIDAR collected by the LIDAR system 150, performs a spatial indexing process to automatically identify the spatial locations at which each of the image frames and the LIDAR data were captured to align the image frames to a 3D model generated using the LIDAR data. After aligning the image frames to the 3D model, the spatial indexing system 130 provides a visualization interface that allows the client device 160 to select a portion of the 3D model to view along with a corresponding image frame side by side. In the embodiment shown in FIG. 1, the spatial indexing system 130 includes a path module 132, a path storage 134, a floorplan storage 136, a model generation module 138, a model storage 140, a model integration module 142, an interface module 144, and a query module 146. In other embodiments, the spatial indexing system 130 may include fewer, different, or additional modules.

The path module 132 receives the image frames in the walkthrough video and the other location and motion data that were collected by the video capture system 110 and determines the path of the video capture system 110 based on the received frames and data. In one embodiment, the path is defined as a 6D camera pose for each frame in the walkthrough video that includes a sequence of frames. The 6D camera pose for each frame is an estimate of the relative position and orientation of the camera 112 when the image frame was captured. The path module 132 can store the path in the path storage 134.

In one embodiment, the path module 132 uses a SLAM (simultaneous localization and mapping) algorithm to simultaneously (1) determine an estimate of the path by inferring the location and orientation of the camera 112 and (2) model the environment using direct methods or using landmark features (such as oriented FAST and rotated BRIEF (ORB), scale-invariant feature transform (SIFT), speeded up robust features (SURF), etc.) extracted from the walkthrough video that is a sequence of frames. The path module 132 outputs a vector of six dimensional (6D) camera poses over time, with one 6D vector (three dimensions for location, three dimensions for orientation) for each frame in the sequence, and the 6D vector can be stored in the path storage 134.

The spatial indexing system 130 can also include floorplan storage 136, which stores one or more floorplans, such as those of environments captured by the video capture system 110. As referred to herein, a floorplan is a to-scale, two-dimensional (2D) diagrammatic representation of an environment (e.g., a portion of a building or structure) from a top-down perspective. In alternative embodiments, the floorplan may be a 3D model of the expected finished construction instead of a 2D diagram (e.g., building information modeling (BIM) model). The floorplan may be annotated to specify positions, dimensions, and types of physical objects that are expected to be in the environment. In some embodiments, the floorplan is manually annotated by a user associated with a client device 160 and provided to the spatial indexing system 130. In other embodiments, the floorplan is annotated by the spatial indexing system 130 using a machine learning model that is trained using a training dataset of annotated floorplans to identify the positions, the dimensions, and the object types of physical objects expected to be in the environment. Different portions of a building or structure may be represented by separate floorplans. For example, the spatial indexing system 130 may store separate floorplans for each floor of a building, unit, or substructure.

The model generation module 138 generates a 3D model of the environment. In some embodiments, the 3D model is based on image frames captured by the video capture system 110. To generate the 3D model of the environment based on image frames, the model generation module 138 may use methods such as structure from motion (SfM), simultaneous localization and mapping (SLAM), monocular depth map generation, or other methods. The 3D model may be generated using the image frames from the walkthrough video of the environment, the relative positions of each of the image frames (as indicated by the image frame's 6D pose), and (optionally) the absolute position of each of the image frames on a floorplan of the environment. The image frames from the video capture system 110 may be stereo images that can be combined to generate the 3D model. In some embodiments, the model generation module 138 generates a 3D point cloud based on the image frames using photogrammetry. In some embodiments, the model generation module 138 generates the 3D model based on LIDAR data from the system 150. The model generation module 138 may process the LIDAR data to generate a point cloud which may have a higher resolution compared to the 3D model generated with image frames. After generating the 3D model, the model generation module 138 stores the 3D model in the model storage 140.

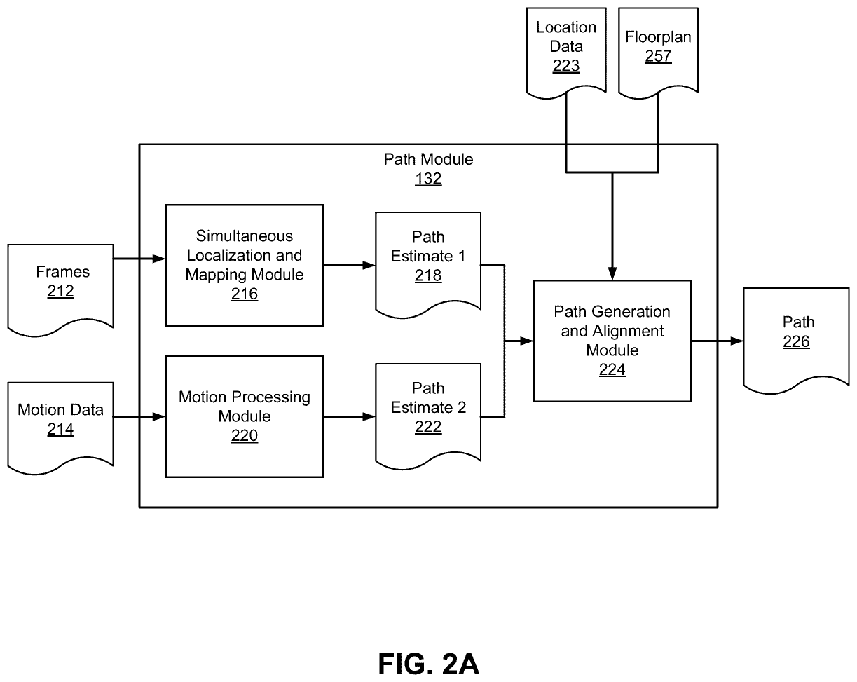

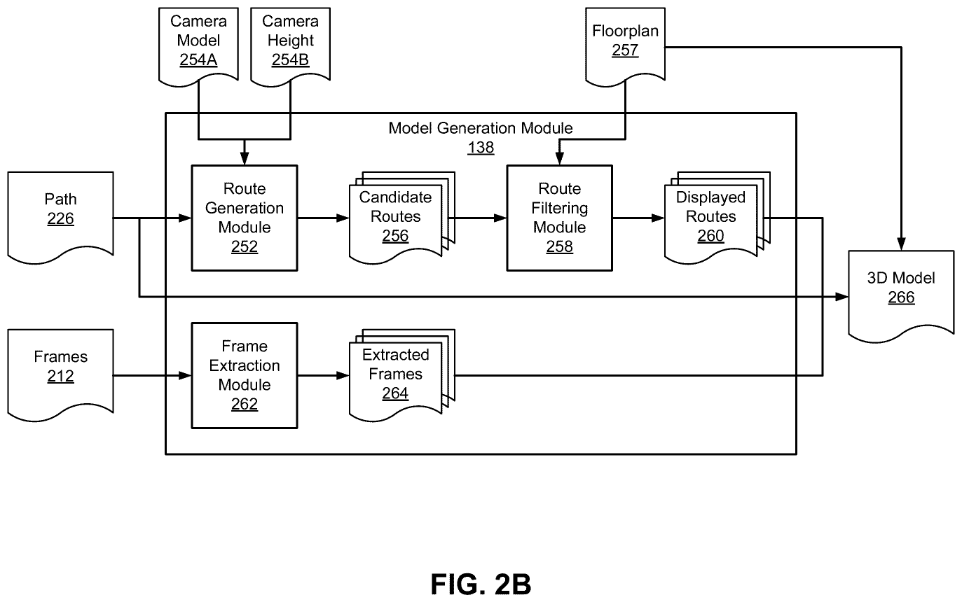

In one embodiment, the model generation module 136 receives a frame sequence and its corresponding path (e.g., a 6D pose vector specifying a 6D pose for each frame in the walkthrough video that is a sequence of frames) from the path module 132 or the path storage 134 and extracts a subset of the image frames in the sequence and their corresponding 6D poses for inclusion in the 3D model. For example, if the walkthrough video that is a sequence of frames are frames in a video that was captured at 30 frames per second, the model generation module 136 subsamples the image frames by extracting frames and their corresponding 6D poses at 0.5-second intervals. An embodiment of the model generation module 136 is described in detail below with respect to FIG. 2B.

In the embodiment illustrated in FIG. 1, the 3D model is generated by the model generation module 138 in the spatial indexing system 130. However, in an alternative embodiment, the model generation module 138 may be generated by a third party application (e.g., an application installed on a mobile device that includes the video capture system 110 and/or the LIDAR system 150). The image frames captured by the video capture system 110 and/or LIDAR data collected by the LIDAR system 150 may be transmitted via the network 120 to a server associated with the application that processes the data to generate the 3D model. The spatial indexing system 130 may then access the generated 3D model and align the 3D model with other data associated with the environment to present the aligned representations to one or more users.

The model integration module 142 integrates the 3D model with other data that describe the environment. The other types of data may include one or more images (e.g., image frames from the video capture system 110), a 2D floorplan, a diagram, and annotations describing characteristics of the environment. The model integration module 142 determines similarities in the 3D model and the other data to align the other data with relevant portions of the 3D model. The model integration module 142 may determine which portion of the 3D model that the other data corresponds to and store an identifier associated with the determined portion of the 3D in association with the other data.

In some embodiments, the model integration module 142 may align the 3D model generated based on LIDAR data with one or more image frames based on time synchronization. As described above, the video capture system 110 and the LIDAR system 150 may be integrated into a single system that captures image frames and LIDAR data at the same time. For each image frame, the model integration module 142 may determine a timestamp at which the image frame was captured and identify a set of points in the LIDAR data associated with the same timestamp. The model integration module 142 may then determine which portion of the 3D model includes the identified set of points and align the image frame with the portion. Furthermore, the model integration module 142 may map pixels in the image frame to the set of points.

In some embodiments, the model integration module 142 may align a point cloud generated using LIDAR data (hereinafter referred to as “LIDAR point cloud”) with another point cloud generated based on image frames (hereinafter referred to as “low-resolution point cloud”). This method may be used when the LIDAR system 150 and the video capture system 110 are separate systems. The model integration module 142 may generate a feature vector for each point in the LIDAR point cloud and each point in the low-resolution point cloud (e.g., using ORB, SIFT, HardNET). The model integration module 142 may determine feature distances between the feature vectors and match point pairs between the LIDAR point cloud and the low-resolution point cloud based on the feature distances. A 3D pose between the LIDAR point cloud and the low-resolution point cloud is determined to produce a greater number of geometric inliers for point pairs using, for example, random sample consensus (RANSAC) or non-linear optimization. Since the low-resolution point cloud is generated with image frames, the LIDAR point cloud is also aligned with the image frames themselves.

In some embodiments, the model integration module 142 may align the 3D model with a diagram or one or more image frames based on annotations associated with the diagram or the one or more image frames. The annotations may be provided by a user or determined by the spatial indexing system 130 using image recognition or machine learning models. The annotations may describe characteristics of objects or surfaces in the environment such as dimensions or object types. The model integration module 142 may extract features within the 3D model and compare the extracted features to annotations. For example, if the 3D model represents a room within a building, the extracted features from the 3D model may be used to determine the dimensions of the room. The determined dimensions may be compared to a floorplan of the construction site that is annotated with dimensions of various rooms within the building, and the model integration module 142 may identify a room within the floorplan that matches the determined dimensions. In some embodiments, the model integration module 142 may perform 3D object detection on the 3D model and compare outputs of the 3D object detection to outputs from the image recognition or machine learning models based on the diagram or the one or more images.

In some embodiments, the 3D model may be manually aligned with the diagram based on input from a user. The 3D model and the diagram may be presented to a client device 160 associated with the user, and the user may select a location within the diagram indicating a location corresponding to the 3D model. For example, the user may place a pin at a location in a floorplan that corresponds to the LIDAR data.

The interface module 144 provides a visualization interface to the client device 160 to present information associated with the environment. The interface module 144 may generate the visualization interface responsive to receiving a request from the client device 160 to view one or more models representing the environment. The interface module 144 may first generate the visualization interface to includes a 2D overhead map interface representing a floorplan of the environment from the floorplan storage 136. The 2D overhead map may be an interactive interface such that clicking on a point on the map navigates to the portion of the 3D model corresponding to the selected point in space. The visualization interface provides a first-person view of the portion of the 3D model that allows the user to pan and zoom around the 3D model and to navigate to other portions of the 3D model by selecting waypoint icons that represent the relative locations of the other portions.

The visualization interface also allows the user to select an object within the 3D model, which causes the visualization interface to display an image frame corresponding to the selected object. The user may select the object by interacting with a point on the object (e.g., clicking on a point on the object). When the interface module 144 detects the interaction from the user, the interface module 144 sends a signal to the query module 146 indicating the location of the point within the 3D model. The query module 146 identifies the image frame that is aligned with the selected point, and the interface module 144 updates the visualization interface to display the image frame. The visualization interface may include a first interface portion for displaying the 3D model and include a second interface portion for displaying the image frame.

In some embodiments, the interface module 144 may receive a request to measure a distance between endpoints selected on the 3D model or the image frame. The interface module 144 may provide identities of the endpoints to the query module 146, and the query module 146 may determine (x, y, z) coordinates associated with the endpoints. The query module 146 may calculate a distance between the two coordinates and return the distance to the interface module 144. The interface module 144 may update the interface portion to display the requested distance to the user. Similarly, the interface module 144 may receive additional endpoints with a request to determine an area or volume of an object.

The client device 160 is any mobile computing device such as a smartphone, tablet computer, laptop computer or non-mobile computing device such as a desktop computer that can connect to the network 120 and be used to access the spatial indexing system 130. The client device 160 displays, on a display device such as a screen, the interface to a user and receives user inputs to allow the user to interact with the interface. An example implementation of the client device is described below with reference to the computer system 600 in FIG. 6.

### II. Path Generation Overview

FIG. 2A illustrates a block diagram of the path module 132 of the spatial indexing system 130 shown in FIG. 1, according to one embodiment. The path module 132 receives input data (e.g., a sequence of frames 212, motion data 214, location data 223, floorplan 257) captured by the video capture system 110 and the LIDAR system 150 and generates a path 226. In the embodiment shown in FIG. 2A, the path module 132 includes a simultaneous localization and mapping (SLAM) module 216, a motion processing module 220, and a path generation and alignment module 224.

The SLAM module 216 receives the sequence of frames 212 and performs a SLAM algorithm to generate a first estimate 218 of the path. Before performing the SLAM algorithm, the SLAM module 216 can perform one or more preprocessing steps on the image frames 212. In one embodiment, the pre-processing steps include extracting features from the image frames 212 by converting the sequence of frames 212 into a sequence of vectors, where each vector is a feature representation of a respective frame. In particular, the SLAM module can extract SIFT features, SURF features, or ORB features.

After extracting the features, the pre-processing steps can also include a segmentation process. The segmentation process divides the walkthrough video that is a sequence of frames into segments based on the quality of the features in each of the image frames. In one embodiment, the feature quality in a frame is defined as the number of features that were extracted from the image frame. In this embodiment, the segmentation step classifies each frame as having high feature quality or low feature quality based on whether the feature quality of the image frame is above or below a threshold value, respectively (i.e., frames having a feature quality above the threshold are classified as high quality, and frames having a feature quality below the threshold are classified as low quality). Low feature quality can be caused by, e.g., excess motion blur or low lighting conditions.

After classifying the image frames, the segmentation process splits the sequence so that consecutive frames with high feature quality are joined into segments and frames with low feature quality are not included in any of the segments. For example, suppose the path travels into and out of a series of well-lit rooms along a poorly lit hallway. In this example, the image frames captured in each room are likely to have high feature quality, while the image frames captured in the hallway are likely to have low feature quality. As a result, the segmentation process divides the walkthrough video that is a sequence of frames so that each sequence of consecutive frames captured in the same room is split into a single segment (resulting in a separate segment for each room), while the image frames captured in the hallway are not included in any of the segments.

After the pre-processing steps, the SLAM module 216 performs a SLAM algorithm to generate a first estimate 218 of the path. In one embodiment, the first estimate 218 is also a vector of 6D camera poses over time, with one 6D vector for each frame in the sequence. In an embodiment where the pre-processing steps include segmenting the walkthrough video that is a sequence of frames, the SLAM algorithm is performed separately on each of the segments to generate a path segment for each segment of frames.

The motion processing module 220 receives the motion data 214 that was collected as the video capture system 110 was moved along the path and generates a second estimate 222 of the path. Similar to the first estimate 218 of the path, the second estimate 222 can also be represented as a 6D vector of camera poses over time. In one embodiment, the motion data 214 includes acceleration and gyroscope data collected by an accelerometer and gyroscope, respectively, and the motion processing module 220 generates the second estimate 222 by performing a dead reckoning process on the motion data. In an embodiment where the motion data 214 also includes data from a magnetometer, the magnetometer data may be used in addition to or in place of the gyroscope data to determine changes to the orientation of the video capture system 110.

The data generated by many consumer-grade gyroscopes includes a time-varying bias (also referred to as drift) that can impact the accuracy of the second estimate 222 of the path if the bias is not corrected. In an embodiment where the motion data 214 includes all three types of data described above (accelerometer, gyroscope, and magnetometer data), and the motion processing module 220 can use the accelerometer and magnetometer data to detect and correct for this bias in the gyroscope data. In particular, the motion processing module 220 determines the direction of the gravity vector from the accelerometer data (which will typically point in the direction of gravity) and uses the gravity vector to estimate two dimensions of tilt of the video capture system 110. Meanwhile, the magnetometer data is used to estimate the heading bias of the gyroscope. Because magnetometer data can be noisy, particularly when used inside a building whose internal structure includes steel beams, the motion processing module 220 can compute and use a rolling average of the magnetometer data to estimate the heading bias. In various embodiments, the rolling average may be computed over a time window of 1 minute, 5 minutes, 10 minutes, or some other period.

The path generation and alignment module 224 combines the first estimate 218 and the second estimate 222 of the path into a combined estimate of the path 226. In an embodiment where the video capture system 110 also collects location data 223 while being moved along the path, the path generation module 224 can also use the location data 223 when generating the path 226. If a floorplan of the environment is available, the path generation and alignment module 224 can also receive the floorplan 257 as input and align the combined estimate of the path 216 to the floorplan 257.

### III. Model Generation Overview

FIG. 2B illustrates a block diagram of the model generation module 138 of the spatial indexing system 130 shown in FIG. 1, according to one embodiment. FIG. 2B illustrates 3D model 266 generated based on image frames. The model generation module 138 receives the path 226 generated by the path module 132, along with the sequence of frames 212 that were captured by the video capture system 110, a floorplan 257 of the environment, and information about the camera 254. The output of the model generation module 138 is a 3D model 266 of the environment. In the illustrated embodiment, the model generation module 138 includes a route generation module 252, a route filtering module 258, and a frame extraction module 262.

The route generation module 252 receives the path 226 and camera information 254 and generates one or more candidate route vectors 256 for each extracted frame. The camera information 254 includes a camera model 254A and camera height 254B. The camera model 254A is a model that maps each 2D point in a frame (i.e., as defined by a pair of coordinates identifying a pixel within the image frame) to a 3D ray that represents the direction of the line of sight from the camera to that 2D point. In one embodiment, the spatial indexing system 130 stores a separate camera model for each type of camera supported by the system 130. The camera height 254B is the height of the camera relative to the floor of the environment while the walkthrough video that is a sequence of frames is being captured. In one embodiment, the camera height is assumed to have a constant value during the image frame capture process. For instance, if the camera is mounted on a hardhat that is worn on a user's body, then the height has a constant value equal to the sum of the user's height and the height of the camera relative to the top of the user's head (both quantities can be received as user input).

As referred to herein, a route vector for an extracted frame is a vector representing a spatial distance between the extracted frame and one of the other extracted frames. For instance, the route vector associated with an extracted frame has its tail at that extracted frame and its head at the other extracted frame, such that adding the route vector to the spatial location of its associated frame yields the spatial location of the other extracted frame. In one embodiment, the route vector is computed by performing vector subtraction to calculate a difference between the three-dimensional locations of the two extracted frames, as indicated by their respective 6D pose vectors.

Referring to the interface module 144, the route vectors for an extracted frame are later used after the interface module 144 receives the 3D model 266 and displays a first-person view of the extracted frame. When displaying the first-person view, the interface module 144 renders a waypoint icon at a position in the image frame that represents the position of the other frame (e.g., the image frame at the head of the route vector). In one embodiment, the interface module 144 uses the following equation to determine the position within the image frame at which to render the waypoint icon corresponding to a route vector:

$${P}_{icon} = {M}_{proj} * {( {M}_{view} )}^{- 1} * {M}_{delta} * {G}_{ring} .$$

In this equation, Mₚᵣₒⱼ is a projection matrix containing the parameters of the camera projection function used for rendering, M_{view} is an isometry matrix representing the user's position and orientation relative to his or her current frame, M_{delta} is the route vector, G_{ring} is the geometry (a list of 3D coordinates) representing a mesh model of the waypoint icon being rendered, and P_{icon} is the geometry of the icon within the first-person view of the image frame.

Referring again to the route generation module 138, the route generation module 252 can compute a candidate route vector 256 between each pair of extracted frames. However, displaying a separate waypoint icon for each candidate route vector associated with a frame can result in a large number of waypoint icons (e.g., several dozen) being displayed in a frame, which can overwhelm the user and make it difficult to discern between individual waypoint icons.

To avoid displaying too many waypoint icons, the route filtering module 258 receives the candidate route vectors 256 and selects a subset of the route vectors to be displayed route vectors 260 that are represented in the first-person view with corresponding waypoint icons. The route filtering module 256 can select the displayed route vectors 256 based on a variety of criteria. For example, the candidate route vectors 256 can be filtered based on distance (e.g., only route vectors having a length less than a threshold length are selected).

In some embodiments, the route filtering module 256 also receives a floorplan 257 of the environment and also filters the candidate route vectors 256 based on features in the floorplan. In one embodiment, the route filtering module 256 uses the features in the floorplan to remove any candidate route vectors 256 that pass through a wall, which results in a set of displayed route vectors 260 that only point to positions that are visible in the image frame. This can be done, for example, by extracting a frame patch of the floorplan from the region of the floorplan surrounding a candidate route vector 256, and submitting the image frame patch to a frame classifier (e.g., a feed-forward, deep convolutional neural network) to determine whether a wall is present within the patch. If a wall is present within the patch, then the candidate route vector 256 passes through a wall and is not selected as one of the displayed route vectors 260. If a wall is not present, then the candidate route vector does not pass through a wall and may be selected as one of the displayed route vectors 260 subject to any other selection criteria (such as distance) that the module 258 accounts for.

The image frame extraction module 262 receives the sequence of 360-degree frames and extracts some or all of the image frames to generate extracted frames 264. In one embodiment, the sequences of 360-degree frames are captured as frames of a 360-degree walkthrough video, and the image frame extraction module 262 generates a separate extracted frame of each frame. As described above with respect to FIG. 1, the image frame extraction module 262 can also extract a subset of image frames from the walkthrough video. For example, if the walkthrough video that is a sequence of frames 212 was captured at a relatively high framerate (e.g., 30 or 60 frames per second), the image frame extraction module 262 can extract a subset of the image frames at regular intervals (e.g., two frames per second of video) so that a more manageable number of extracted frames 264 are displayed to the user as part of the 3D model.

The floorplan 257, displayed route vectors 260, path 226, and extracted frames 264 are combined into the 3D model 266. As noted above, the 3D model 266 is a representation of the environment that comprises a set of extracted frames 264 of the environment, the relative positions of each of the image frames (as indicated by the 6D poses in the path 226). In the embodiment shown in FIG. 2B, the 3D model also includes the floorplan 257, the absolute positions of each of the image frames on the floorplan, and displayed route vectors 260 for some or all of the extracted frames 264.

IV. Localization of Images within an Environment

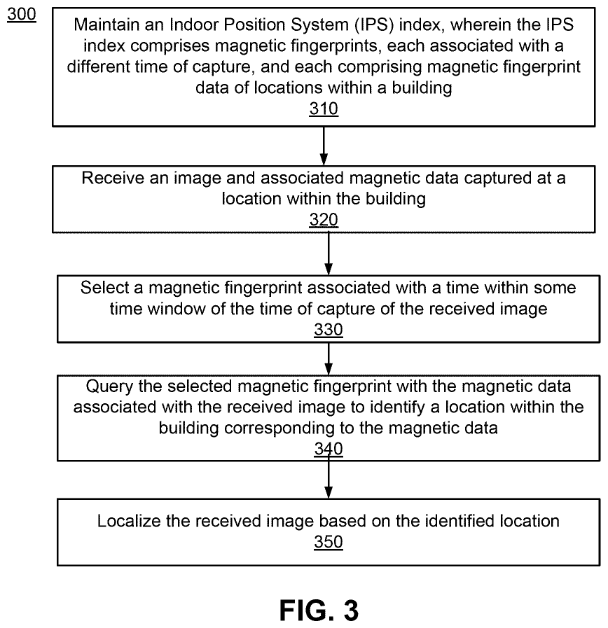

FIG. 3 is a flow chart illustrating an example method 300 for localizing images within an environment such as a building, according to one embodiment. In other embodiments, the method 300 may include additional, fewer, or different steps, and the steps shown in FIG. 3 may be performed in a different order. A system, such as the spatial indexing system 130, may be used to perform the steps of the method 300.

The system maintains 310 an IPS index. The IPS index includes magnetic fingerprints, each associated with a different time of capture, and each comprising magnetic fingerprint data of various locations within a building. Magnetic fingerprint data are collected during walkthroughs of the building and stored in the IPS index database.

In some embodiments, to build the IPS index, a capture device such as a mobile device with a dedicated application installed, is used to collect magnetic fingerprint data during walkthroughs of the building. The capture device utilizes a magnetometer sensor to measure and capture the Earth's geomagnetic field at various locations within the building, allowing for the creation of unique magnetic fingerprints data for each location within the building. For example, an operator may carry out a walkthrough of the building using the capture device. As the operator moves throughout the building, the capture device's magnetometer sensor collects magnetic field data at different locations, creating measurements that will become magnetic fingerprints. At the same time, the capture device captures video frames (such as 360-degree video) using a video capture device during a walkthrough. The captured video frames are processed as described herein in order to localize each frame within the building, likewise, enabling the localization of the magnetic field data captured in conjunction with the localized video frames. For instance, a captured video frame can be aligned with a floor plan of a building using, for example, features within the video frame, such as a wall and door positions, and aligning the features with corresponding features within the floor plan. Once the location of the captured video frame is determined, magnetic field data captured in conjunction with the captured video frame is associated with the same location within the building, and is included within a magnetic fingerprint at this location.

Once the magnetic fingerprints and their associated spatial locations have been collected during the walkthroughs, they are stored in a database (or repository) to create the IPS index. The database can be hosted on a suitable server or storage system accessible by the system responsible for processing the IPS index data. In some embodiments, walkthroughs may be performed for only portions of a building and it is possible to piece together multiple walkthroughs into a composite fingerprint for storage into the IPS index.

In some embodiments, maintaining the IPS index involves periodic updates to ensure its accuracy and relevance as changes occur within the building's structure or interior. The IPS index may be updated after each new walkthrough. Periodic walkthroughs may be conducted during different construction stages or when significant changes occur to the building's structure or interior, such as alterations to the layout or the addition or removal of elements within the building. These new magnetic fingerprints, collected during subsequent walkthroughs, are then added to the IPS index database to incorporate the changes. This updated information allows the system to provide correct localization for images even as the building changes over time.

Continuing with FIG. 3, the system receives an image and associated magnetic data captured at a location within the building. In some embodiments, a user can utilize a mobile application installed on a smartphone or a dedicated device equipped with a camera and magnetic sensors, to capture both images and magnetic data. Users or operators would use this application within the building to take pictures at desired locations. When a user captures an image at a specific location within the building using the mobile application, the image data is collected along with relevant metadata, such as the timestamp of the capture. Magnetic data is also captured using the magnetic sensors (such as a magnetometer) in the device. This magnetic data represents the measured magnetic field at the location where the image was taken and, in some embodiments, the measured magnetic field at the locations where the user walked previously. The mobile application can send the captured image, its associated magnetic data, and the timestamp to a database or a server for further processing. The server can retrieve this information and initiates the process of localizing the image based on the magnetic fingerprint data available in the IPS index.

Continuing with FIG. 3, the system selects 330 a magnetic fingerprint associated with a time within some time window of capture of the received image. In some embodiments, the system can retrieve the timestamp of the received image, which was also associated with the magnetic data captured using the mobile application, and search the IPS index, which contains multiple magnetic fingerprints, each associated with a different time of capture. The system can search through the timestamps of magnetic fingerprints in the IPS index to find the one that is closest to the received image's timestamp. Advantageously, this may ensure that the magnetic fingerprint selected for comparison considers any changes or variations in the magnetic field data that may have occurred over time.

Based on the comparison of timestamps, the system can select the magnetic fingerprint from the IPS index whose associated time of capture is within some time window of capture of the received image. Selecting a magnetic fingerprint with a similar time of capture may minimize potential discrepancies caused by changing conditions or alterations within the building.

Continuing with FIG. 3, the system queries 340 the selected magnetic fingerprint with the magnetic data associated with the received image to identify a location within the building corresponding to the magnetic data. In some embodiments, the system can compare the magnetic data associated with the received image to the magnetic fingerprint data of the selected magnetic fingerprint. This comparison may involve analyzing the similarities between the magnetic data of the image and the magnetic fingerprint, taking into account the variations in magnetic field measurements at different points within the building. For each location within the building, the system can calculate a similarity metric based on the comparison between the image magnetic data and the magnetic fingerprint data of the selected magnetic fingerprint for that location. This similarity metric might include correlation coefficients or other statistical measures that quantify the degree of similarity between the two sets of magnetic data.

In some embodiments, the received image data may be used to support magnetic fingerprint localization. For example, the system may compute similarity scores between the received image and each frame of video frames (or images) of walkthroughs stored by the system. This may be achieved using image comparison techniques such as feature matching or template matching. The system may combine the image similarity scores and the magnetic similarity metric to create a more reliable and accurate similarity measure for each location within the building. In some cases, the IPS index may store the image data corresponding to each fingerprint.

In some embodiments, after calculating the similarity metrics for all locations within the building, the system can identify the location with the highest similarity metric value, indicating the closest match between the image's magnetic data and the magnetic fingerprint data associated with that location. The identified location corresponds to the magnetic data of the received image, which may signify the location where the image was captured. In some embodiments, the system can identify the location with the highest combined similarity score, incorporating both image and magnetic similarities, as the most accurate position for the captured image within the building. Once the system identifies the location within the building, it can then use this information to localize the received image, providing an accurate position for the image within the building's layout or a 3D model.

Continuing with FIG. 3, the system localizes 350 the received image based on the identified location. In some embodiments, once the location within the building has been identified (based on the highest similarity metric value from the previous step), the system can assign corresponding coordinates (for e.g., x, y, z or latitude, longitude, altitude) to the received image. This step effectively relates the received image to a specific position within the building layout. In some embodiments, the system may annotate or tag the received image with location information, such as room names, floor numbers, or any relevant descriptions that provide context to the localization result. This annotation may help users understand the precise location of the captured image within the building. With the location information for the received image established, the system can correlate the localized image with a building map, floor plan, or 3D model.

In some embodiments, once the system identifies the most likely location, it can cause a device to display that location on the graphical user interface (GUI) of a client device. By visualizing the location, users can easily understand where the captured image was taken within the building. This information can be beneficial for tracking construction progress, finding objects or people, monitoring activities, or assisting with navigation within the building.

Furthermore, the magnetic data can be used with image feature data (e.g., comparison of image features/objects identified within the images to floorplan or model), and pedestrian data (accelerometer, steps, etc.) captured when the images were captured to track construction progress, find objects or people, monitor activities, or assist with navigation within the building.

In some embodiments, the system may process magnetic data along with image feature data and pedestrian data to enable accurate tracking of construction progress. The magnetic data creates a magnetic fingerprint map based on geomagnetic measurements. This map, combined with computer vision algorithms that extract image features and pedestrian data from workers' mobile devices, may provide a comprehensive overview of construction progress by identifying areas that are on schedule or require attention.

In some embodiments, the system may be used to localize objects or people within a construction site by using magnetic data. Creating a magnetic fingerprint map of the site may allow for unique environment characterization. Combining this map with image feature data obtained from computer vision algorithms and pedestrian data may aid in precisely pinpointing the location of desired objects or individuals, making it easier to locate them in real-time.

Monitoring construction site activities can be enhanced by using magnetic data in addition to image feature data and pedestrian data. The generated magnetic fingerprint map, coupled with images analyzed through computer vision algorithms and pedestrian movement patterns, may ensure a more comprehensive understanding of site operations. This data integration may allow for better safety protocol compliance and observation of specific tasks and events.

Navigation assistance within a building may benefit significantly from the integration of magnetic data, image feature data, and pedestrian data. Creating a magnetic fingerprint map for critical navigation points may be combined with image feature analysis and user movement data to provide real-time location updates. Users may be guided from their current location to their intended destination via the overlaid floor plan or model, making indoor navigation more accurate and secure.

Use of magnetic data may provide object tracking on construction sites. In this approach, objects such as tools, vehicles, and construction materials are equipped with Bluetooth transmitters. When an operator performs a walkthrough using a capture device (such as a video capture device, an image capture device, a magnetic field capture device, a mobile device, or any device configured to capture the data described herein), and they happen to walk near an object, the capture device collects both the Bluetooth signal ID (or signature) of the object and the magnetic data associated with the object's location. This information may be used to create and maintain a database of object locations across the construction site. The database can be utilized for various purposes, such as locating tools, vehicles, or materials on large job sites. Implementing this method enables precise and up-to-date tracking of resources within a construction site, ultimately enhancing operational efficiency, minimizing the time spent searching for misplaced items, and optimizing inventory management processes.

In some embodiments, to build the database of object locations, operators may attach Bluetooth transmitters to the objects they want to track. Then the operator performs a walkthrough of the construction site using a capture device (e.g., a mobile device equipped with a dedicated application for Bluetooth and magnetic data collection). As the operator walks near an object, the capture device will detect the object's Bluetooth transmitter, collect its Bluetooth signal ID, and record the magnetic data at the object's location. The collected data may be stored in a centralized database, which may be hosted on a server or storage system that can be accessed and updated as needed. To keep the objects' location information current, the database may be regularly updated by having operators perform regular walkthroughs.

V. Localization of a Device within an Environment

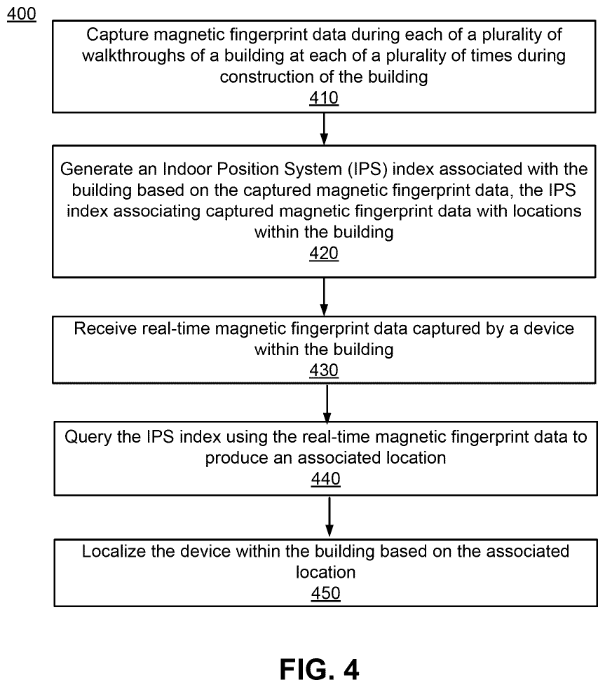

FIG. 4 is a flow chart illustrating an example method 400 for localizing a device within an environment such as a building, according to one embodiment. In other embodiments, the method 400 may include additional, fewer, or different steps, and the steps shown in FIG. 4 may be performed in a different order. A system, such as the spatial indexing system 130, may be used to perform the steps of the method 400.

The system captures 410 magnetic fingerprint data during each of a plurality of walkthroughs of a building at each of a plurality of times during construction of the building. In some embodiments, the system captures magnetic fingerprint data during each of the plurality of walkthroughs by recording a timestamp associated with each captured magnetic fingerprint data and storing the magnetic fingerprint data and associated timestamp in a database. In this approach, recording the timestamp includes capturing the precise date and time when each magnetic fingerprint data point is collected using the magnetometer sensor during a walkthrough. The system can append the date and time information to each magnetic fingerprint data point to establish when the data was captured relative to other magnetic fingerprint measurements. This temporal relationship can allow the system to maintain a chronological sequence of magnetic field measurements across multiple walkthroughs. Storing the magnetic fingerprint data and associated timestamp includes saving both the magnetic field measurements and their corresponding timestamps in a structured database designed to maintain the relationship between the magnetic data and its capture time.

The database may be implemented using standard database management systems that support timestamp-based indexing and querying, providing efficient retrieval of magnetic fingerprint data based on temporal criteria. The stored data can include three-dimensional magnetic field vectors measured at each location along with their precise capture times.

In some embodiments, the system captures magnetic fingerprint data during each of the plurality of walkthroughs by recording a timestamp associated with each captured magnetic fingerprint data. The timestamp may correspond to a construction progress of the building. In this approach, recording the timestamp includes capturing the precise date and time when each magnetic fingerprint data point is collected during a walkthrough, where the timestamp can serve as a marker for the construction state of the building. The system uses these timestamps to organize magnetic fingerprint data according to different phases of construction, providing an indication of how magnetic fields change as the building progresses. For example, timestamps may correspond to specific construction milestones such as completion of steel framework, installation of electrical systems, or addition of concrete walls, each of which significantly affects the local magnetic fields. The system can store the magnetic fingerprint data and associated timestamp in a database to track changes in magnetic fingerprint data as construction materials and building structures are modified. Storing the magnetic fingerprint data and associated timestamp can include saving the magnetic field measurements, timestamps, and construction state information in a database that maintains relationships between magnetic signatures and building modifications. This database can track how magnetic fields evolve as new materials are added and structures are modified.

The system can update the database on a periodic basis to maintain current magnetic fingerprint data reflecting recent construction changes. For example, the system updates the database regularly, such as daily or weekly, by conducting new walkthroughs to capture fresh magnetic fingerprint data that reflects recent construction changes. The system updates the database to maintain current magnetic signatures that match the building's latest state. Each update creates a new temporal layer in the database, allowing the system to track magnetic field changes throughout the construction process.

Continuing with FIG. 4, the system generates 420 an IPS index associated with the building based on the captured magnetic fingerprint data. The IPS index can associate captured magnetic fingerprint data with locations within the building.

In some embodiments, the system generates the IPS index by associating each captured magnetic fingerprint data with corresponding location coordinates within the building. For example, the system associates each captured magnetic fingerprint data with corresponding location coordinates by mapping the magnetic field measurements to specific coordinates (e.g., x, y, z) within the building's coordinate system. For each magnetic fingerprint data point captured during a walkthrough, the system determines its location coordinates through a multi-step process: first, video or image frames (e.g., 360-degree video frames) are mapped to locations on the floorplan (for e.g., using LIDAR data captured simultaneously with the video or image frames); then, magnetic fingerprint data is mapped to these video or image frames using timestamps, thereby mapping the magnetic fingerprint data to precise spatial coordinates within the building. This process can create a direct link between each magnetic measurement and its precise spatial location within the building. Systems and methods for mapping image frames to locations on a floorplan are described in U.S. Pat. No. 10,467,804, entitled “Automated spatial indexing of images based on floorplan features,” which is hereby incorporated by reference.

The system stores the magnetic fingerprint data and associated location coordinates in a database. For example, the system saves both the three-dimensional magnetic field vectors and their corresponding spatial coordinates in the database. In addition, the system indexes the stored data based on one or more parameters. Indexing the stored data includes creating efficient data structures based on parameters such as spatial coordinates, magnetic field strength, or timestamp. These indices can provide quick retrieval of magnetic fingerprint data when queried with parameters like location ranges or magnetic field characteristics, facilitating rapid location lookup during real-time positioning tasks.

In some embodiments, the system generates the IPS index by determining location coordinates within the building for each captured magnetic fingerprint data using a floorplan of the building. For example, the system uses the floorplan of the building to establish precise coordinates for each magnetic fingerprint data point collected during walkthroughs. The system references the building's floorplan to identify features such as structural features, room boundaries, and fixed landmarks. The features serve as reference points for establishing the spatial location of each magnetic measurement. In some embodiments, the system aligns magnetic fingerprint data with corresponding locations on the floorplan by mapping 360-degree video frames to floorplan locations and mapping magnetic fingerprint data to the localized video frames via timestamps.

The system stores the magnetic fingerprint data, the location coordinates, and construction state data in the database. The construction state data indicates structural changes affecting magnetic fields within the building. The system creates database entries that combine the magnetic field measurements with their spatial coordinates. In some embodiments, the system also stores, along with the magnetic field measurements, corresponding construction state information describing structural changes affecting the magnetic fields. The system organizes this data to track how magnetic signatures evolve with construction progress, such as the installation of steel beams, electrical systems, or concrete walls. The system indexes the stored data by creating multi-dimensional indices based on both temporal parameters (construction phases, timestamps) and spatial parameters (coordinates, zones, floors). This indexing structure provides efficient querying of magnetic fingerprint data for specific construction stages and locations, allowing the system to retrieve the most relevant magnetic signatures for any given point in the building's construction timeline and physical space.

Continuing with FIG. 4, the system receives 430 real-time magnetic fingerprint data captured by a device within the building. For example, a mobile device captures magnetic fingerprint data within the building. The mobile device's built-in magnetometer sensor measures the local magnetic field vectors at the device's current position. The magnetometer samples the ambient magnetic field in three dimensions (x, y, z) at a predetermined frequency (e.g., ranging from 10-100 Hz), measuring both the Earth's geomagnetic field and its distortions caused by building materials and structures. The measurements may be processed through the device's sensor fusion system to account for device orientation and to filter out noise.

The device records a timestamp associated with the magnetic fingerprint data. The device can append time data to each magnetic fingerprint measurement as it is captured. For example, the device's internal clock generates timestamps to synchronize the magnetic field measurements with the device's other sensor data. The timestamp provides temporal alignment of the magnetic data with other positioning information and comparison with time-indexed entries in the IPS index. The system may operate in two modes: local and cloud processing modes. In a local processing mode, the IPS index is generated in the cloud (e.g., an online server) and then sent to a mobile device. A user may alternatively download the IPS index onto the mobile device. When using the IPS index, the mobile device matches live magnetic fingerprint data against the downloaded IPS index to calculate its location in real time. Processing the IPS index locally on the mobile device provides real-time localization without network latency, allows operation in areas with poor network connectivity, or maintains location services even when offline. In a cloud processing mode, the mobile device transmits the magnetic fingerprint data and the timestamp to an online server that performs the matching against the IPS index. The device can transmit this data to the online server either in real-time or in batches to optimize network usage.

Continuing with FIG. 4, the system queries 440 the IPS index using the real-time magnetic fingerprint data to produce an associated location. For example, the system executes a database query against the IPS index using the received real-time magnetic fingerprint data as search criteria. The query compares the magnetic field vectors from the real-time magnetic fingerprint data against stored magnetic fingerprint data in the database. The system may employ pattern matching algorithms or similarity metrics to identify stored magnetic fingerprints that most closely match the real-time measurements. The query considers the temporal aspect by prioritizing magnetic fingerprint data from construction phases closest to the current time, as building modifications can alter magnetic field patterns. The location coordinates associated with the best-matching magnetic fingerprint are then retrieved as the query result, representing the likely position where the real-time magnetic fingerprint data was captured.

Continuing with FIG. 4, the system localizes 450 the device within the building based on the associated location. In one approach, the system processes the location coordinates retrieved from the IPS query to establish the device's precise position within the building. The localization process can include mapping the matched location coordinates to the building's spatial reference frame, which may include floor number, room identification, and specific coordinates (e.g., x, y, z). The system may apply additional refinements to improve accuracy, such as smoothing algorithms to account for potential noise in the magnetic measurements or confidence scoring to indicate the reliability of the location determination. The final localized position is then translated into a format suitable for user need, such as updating a user's position on a floor plan display, triggering location-based services, or logging the device's position for tracking purposes. This localized position serves as the system's best estimate of the device's current location within the building based on the magnetic fingerprint matching results.

The following is an exemplary embodiment of the present subject matter. In operation, after generating the IPS index through walkthroughs, the IPS index is downloaded to a mobile device. The mobile device then runs a sensor fusion system that continuously tracks user location by combining real-time IMU data with magnetic fingerprint data comparisons against the stored IPS index. This provides position tracking as users move through an environment such as a building. When a user captures an image, the sensor fusion system can provide the most likely location at the time of capture and present this on a user interface of the mobile device for user verification. In some embodiments, the sensor fusion system may also analyze features within the captured image and compare them to the walkthrough video frames to help refine the location estimate. Once the user verifies the position, this feedback is incorporated back into the sensor fusion algorithm to improve its ongoing location estimates. Beyond image localization, the sensor fusion system serves multiple purposes: it can display the user's current position in real-time, enable location-based alerts and services, and maintain continuous tracking throughout the building. This integrated approach provides reliable indoor positioning by combining magnetic fingerprint matching, motion tracking, and optional image-based refinements.

VI. Tracking a Location of a Device within an Environment

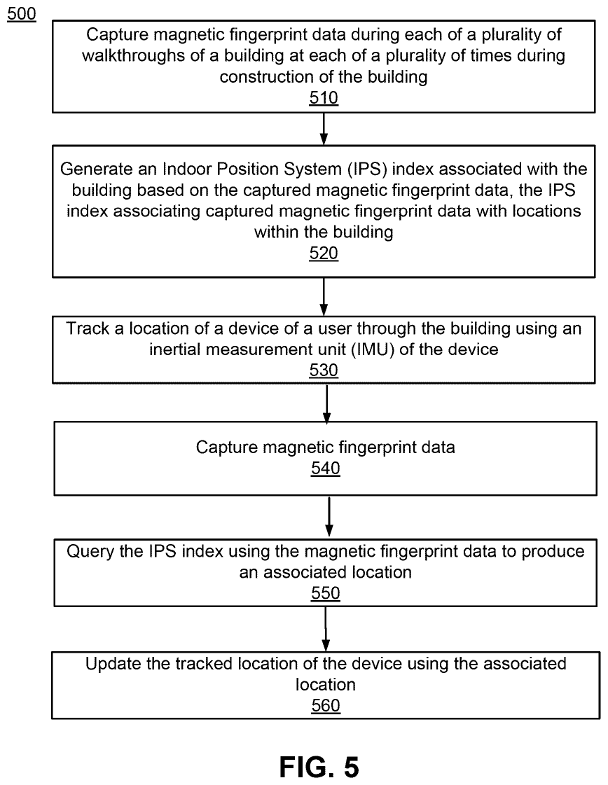

FIG. 5 is a flow chart illustrating an example method 500 for localizing images within an environment such as a building, according to one embodiment. In other embodiments, the method 300 may include additional, fewer, or different steps, and the steps shown in FIG. 3 may be performed in a different order. A system, such as the spatial indexing system 130, may be used to perform the steps of the method 500.

The system captures 510 magnetic fingerprint data during each of a plurality of walkthroughs of a building at each of a plurality of times during construction of the building. In some embodiments, this step is similar to step 410 of FIG. 4.

Continuing with FIG. 5, the system generates 520 an IPS index associated with the building based on the captured magnetic fingerprint data. The IPS index associates captured magnetic fingerprint data with locations within the building. When the IPS is queried with input magnetic fingerprint data by the system or a user device, it identifies a location within the building at which the input magnetic fingerprint data was captured. In some embodiments, this step is similar to step 420 of FIG. 4.

Continuing with FIG. 5, the system tracks 530 a location of a device of a user through the building using an inertial measurement unit (IMU) of the device. In some embodiments, the user device collects IMU measurements from the device's accelerometer and gyroscope sensors at fixed time intervals. The accelerometer data can provide linear acceleration measurements along three axes (x, y, z), while the gyroscope data can provide angular velocity measurements around these axes. The user device processes the sensor data locally. Processing sensor data locally on the user device provides real-time position updates without network latency, and continuous operation even in areas with poor network connectivity. Alternatively, in some embodiments, the user device may transmit the sensor data to an online server for processing. The transmitted data can be sent either in real-time or in batches to optimize network usage. In response to receiving the sensor data, the system (e.g., either the local user device or the online server) determines linear acceleration and angular velocity by processing the sensor data through calibration matrices to account for sensor biases and scaling factors, applying noise reduction filters, and converting the measurements into standard units (e.g., m/s² for acceleration, rad/s for angular velocity). The system calculates position updates of the device based on the linear acceleration data and/or the angular velocity data. For example, calculating position updates includes double-integrating the linear acceleration data to obtain displacement, integrating angular velocity to track orientation changes, and combining these calculations using sensor fusion algorithms or machine learning techniques to estimate the device's new position relative to its previous known location, while accounting for accumulated errors through techniques such as zero-velocity updates during stationary periods. Machine learning techniques for position estimation may include deep neural networks, recurrent neural networks (RNNs), long short-term memory (LSTM) networks, and Kalman filters for processing sensor data and predicting device positions.

In some embodiments, the user device collects measurements from the accelerometer (linear acceleration), gyroscope (angular velocity), and magnetometer (magnetic field) sensors. In response to receiving these measurements, the system performs pedestrian dead reckoning. In doing this, the system analyzes accelerometer data patterns to detect step events and estimate step length based on biomechanical models of human walking. The system processes gyroscope data through complementary filters to track changes in device orientation. The system uses magnetometer readings to determine absolute heading by measuring the local magnetic field direction. The system implements a sensor fusion algorithm (such as a Kalman filter or a particle filter) or machine learning approaches (such as deep neural networks, RNNs, or LSTM networks) to optimally combine these measurements, calculating position updates by accumulating the detected steps along the determined heading direction while continuously adjusting for orientation changes and refining the position estimate based on the processed sensor data.

Continuing with FIG. 5, to avoid IMU drift, the user device captures 540 magnetic fingerprint data. In some embodiments, the system uses a sensor fusion approach to maintain accurate device positioning. The system may continuously process three inputs together: (1) the IPS magnetic index (either stored locally on the user device or online); (2) real-time pedestrian dead reckoning (PDR) data generated from IMU measurements, and (3) the magnetic fingerprint data captured by the device's magnetometer. This integrated approach may provide more robust positioning than using any single input alone, as each data source helps compensate for limitations in the others. The continuous nature of the processing may provide position accuracy without requiring periodic corrections or drift detection.

Continuing with FIG. 5, the system queries 550 the IPS index using the magnetic fingerprint data to produce an associated location. For example, in response to receiving the magnetic fingerprint data from the user device, the system compares the magnetic fingerprint data against the stored IPS index. In some embodiments, using techniques such as conditional random fields or particle filters, the system processes both PDR position estimates and magnetic fingerprint matching. For magnetic matching, the system compares the user device's current magnetic measurements against the stored IPS index fingerprints by analyzing magnetic field strength, direction, and patterns. The system then combines the PDR position estimates with these magnetic comparison results to generate an optimal estimate of the user device's location on the floorplan. This combined approach can leverage both the continuous motion tracking from PDR and the absolute positioning from magnetic matching to maintain accurate location estimates.

In some embodiments, the query process compares the received magnetic fingerprint data against the stored magnetic fingerprints data from a most recent construction phase, using pattern matching algorithms to identify the closest matching magnetic fingerprint data. The system can calculate similarity scores between the input magnetic fingerprint data and the stored fingerprint data, considering factors such as magnetic field strength, direction, and pattern correlation. The query returns location coordinates associated with the best-matching magnetic fingerprint data, representing the most likely position where the user device captured the magnetic fingerprint data.

Continuing with FIG. 5, the system updates 560 the tracked location of the device using the associated location. For example, the system updates the device's tracked location by incorporating the IPS-derived position (associated location) into the existing location tracking system. This update process can include adjusting the device's current position estimate to align with the magnetic fingerprint-based location, effectively correcting for accumulated IMU drift. The system may use a weighted averaging algorithm (or a Kalman filter, a particle filter, a conditional random field, etc.) to combine the IPS-derived location with recent motion data, providing a smooth transition to the corrected position while maintaining continuity in the device's tracked trajectory. The updated position then serves as a new reference point for subsequent IMU-based tracking, resetting accumulated drift errors and providing a more accurate starting position for future movement calculations.

### VII. Hardware Components

FIG. 6 is a block diagram illustrating a computer system 600 upon which embodiments described herein may be implemented. For example, in the context of FIG. 1, the video capture system 110, the LIDAR system 150, the spatial indexing system 130, or the client device 160 may be implemented using the computer system 600 as described in FIG. 6. The video capture system 110, the LIDAR system 150, the spatial indexing system 130, or the client device 160 may also be implemented using a combination of multiple computer systems 600 as described in FIG. 6. The computer system 600 may be, for example, a laptop computer, a desktop computer, a tablet computer, or a smartphone.

In one implementation, the system 600 includes processing resources 601, main memory 603, read only memory (ROM) 605, storage device 607, and a communication interface 609. The system 600 includes at least one processor 601 for processing information and a main memory 603, such as a random access memory (RAM) or other dynamic storage device, for storing information and instructions to be executed by the processor 601. Main memory 603 also may be used for storing temporary variables or other intermediate information during execution of instructions to be executed by processor 601. The system 600 may also include ROM 605 or other static storage device for storing static information and instructions for processor 601. The storage device 607, such as a magnetic disk or optical disk, is provided for storing information and instructions.

The communication interface 609 can enable system 600 to communicate with one or more networks (e.g., the network 140) through use of the network link (wireless or wireline). Using the network link, the system 600 can communicate with one or more computing devices, and one or more servers. The system 600 can also include a display device 611, such as a cathode ray tube (CRT), an LCD monitor, or a television set, for example, for displaying graphics and information to a user. An input mechanism 613, such as a keyboard that includes alphanumeric keys and other keys, can be coupled to the system 600 for communicating information and command selections to processor 601. Other non-limiting, illustrative examples of input mechanisms 613 include a mouse, a trackball, touch-sensitive screen, or cursor direction keys for communicating direction information and command selections to processor 601 and for controlling cursor movement on display device 611. Additional examples of input mechanisms 613 include a radio-frequency identification (RFID) reader, a barcode reader, a three-dimensional scanner, and a three-dimensional camera.

According to one embodiment, the techniques described herein are performed by the system 600 in response to processor 601 executing one or more sequences of one or more instructions contained in main memory 603. Such instructions may be read into main memory 603 from another machine-readable medium, such as storage device 607. Execution of the sequences of instructions contained in main memory 603 causes processor 601 to perform the process steps described herein. In alternative implementations, hard-wired circuitry may be used in place of or in combination with software instructions to implement examples described herein. Thus, the examples described are not limited to any specific combination of hardware circuitry and software.

### VIII. Additional Considerations

As used herein, the term “includes” followed by one or more elements does not exclude the presence of one or more additional elements. The term “or” should be construed as a non-exclusive “or” (e.g., “A or B” may refer to “A,” “B,” or “A and B”) rather than an exclusive “or.” The articles “a” or “an” refer to one or more instances of the following element unless a single instance is clearly specified.

The drawings and written description describe example embodiments of the present disclosure and should not be construed as enumerating essential features of the present disclosure. The scope of the invention should be construed from any claims issuing in a patent containing this description.

What is claimed is:

1. A method comprising:
capturing magnetic fingerprint data during each of a plurality of walkthroughs of a building at each of a plurality of times during construction of the building;
generating an Indoor Position System (IPS) index associated with the building based on the captured magnetic fingerprint data, the IPS, when queried with input magnetic fingerprint data, configured to identify a location within the building at which the input magnetic fingerprint data was captured;
receiving an image and associated magnetic fingerprint data captured within the building;
querying the IPS using the associated magnetic fingerprint data to produce an associated location; and
localizing the received image based on the associated location.

2. The method of claim 1, wherein maintaining the IPS index comprises:
collecting magnetic fingerprint data during a walkthrough of the building; and
storing the magnetic fingerprint data in a database to update the IPS index.

3. The method of claim 2, wherein the magnetic fingerprint data is captured by one or more of a video capture system, a magnetic data capture system, and a mobile device configured to capture magnetic fingerprint data.

4. The method of claim 1, wherein receiving the image and associated magnetic data comprises:
providing an application on a mobile device, wherein the application is designed to capture the image and associated magnetic data; and
providing the image captured with the application at a desired location within the building, wherein the application collects image data, magnetic data and timestamp data.

5. The method of claim 1, further comprising selecting a plurality of magnetic fingerprints, and generating a weighted magnetic fingerprint based on the selected plurality of magnetic fingerprints.

6. The method of claim 5, wherein the selected plurality of magnetic fingerprints comprises magnetic fingerprints closest in time to the time of capture of the received image.

7. The method of claim 1, wherein querying the IPS using the associated magnetic fingerprint data comprises:
determining, for each location within the building, a metric based on a comparison between the image magnetic data and the magnetic fingerprint data of the selected magnetic fingerprint for that location, the metric comprising a measure of similarity or correlation between the image magnetic data and the magnetic fingerprint data of the selected magnetic fingerprint for that location.

8. The method of claim 1, wherein localizing the received image within the building comprises:
determining which location within the building is associated with a closest matching magnetic fingerprint data to the captured image's magnetic data.

9. The method of claim 1, further comprising:
correlating the localized received image with a 3D model of the building at a location within the 3D model corresponding to the identified location.

10. The method of claim 1, wherein identifying the location within the building corresponding to the magnetic data further comprises comparing features from the image to one or more of a floorplan of the building, previously captured video of the building, and a three-dimensional model of the building, and determining the identified location based additionally on this comparison.

11. A method comprising:
capturing magnetic fingerprint data during each of a plurality of walkthroughs of a building at each of a plurality of times during construction of the building;
generating an Indoor Position System (IPS) index associated with the building based on the captured magnetic fingerprint data, the IPS index associating captured magnetic fingerprint data with locations within the building;
receiving real-time magnetic fingerprint data captured by a device within the building;
querying the IPS index using the real-time magnetic fingerprint data to produce an associated location; and
localizing the device within the building based on the associated location.

12. The method of claim 11, wherein capturing magnetic fingerprint data during each of the plurality of walkthroughs comprises:
recording a timestamp associated with each captured magnetic fingerprint data; and
storing the magnetic fingerprint data and associated timestamp in a database.

13. The method of claim 11, wherein capturing magnetic fingerprint data during each of the plurality of walkthroughs comprises:
recording a timestamp associated with each captured magnetic fingerprint data, wherein the timestamp indicates construction progress of the building;
storing the magnetic fingerprint data and associated timestamp in a database to track changes in magnetic fingerprint data as construction materials and building structures are modified; and
updating the database on a periodic basis to maintain current magnetic fingerprint data reflecting recent construction changes.

14. The method of claim 11, wherein generating the IPS index comprises:
associating each captured magnetic fingerprint data with corresponding location coordinates within the building;
storing the magnetic fingerprint data and associated location coordinates in a database; and
indexing the stored data based on one or more parameters.

15. The method of claim 11, wherein generating the IPS index comprises:
determining location coordinates within the building for each captured magnetic fingerprint data using a floorplan of the building;
storing the magnetic fingerprint data, the location coordinates, and construction state data in a database, wherein the construction state data indicates structural changes affecting magnetic fields within the building; and
indexing the stored data based on temporal and spatial parameters to provide querying of magnetic fingerprint data corresponding to specific construction phases and locations within the building.

16. The method of claim 11, wherein receiving real-time magnetic fingerprint data comprises:
capturing the magnetic fingerprint data using a magnetometer sensor on a mobile device within the building;
recording a timestamp associated with the magnetic fingerprint data; and
transmitting the magnetic fingerprint data and the timestamp to a processing server.

17. A method comprising:
capturing magnetic fingerprint data during each of a plurality of walkthroughs of a building at each of a plurality of times during construction of the building;
generating an Indoor Position System (IPS) index associated with the building based on the captured magnetic fingerprint data, the IPS index associating captured magnetic fingerprint data with locations within the building;
tracking a location of a device of a user through the building using an inertial measurement unit (IMU) of the device;
to avoid IMU drift, capturing magnetic fingerprint data by the device;
querying the IPS using the magnetic fingerprint data to produce an associated location; and
updating the tracked location of the device using the associated location.

18. The method of claim 17, wherein tracking the location of the device of the user comprises:
receiving, at predetermined intervals, sensor data from a plurality of IMU sensors of the device, wherein the plurality of IMU sensors comprise an accelerometer and a gyroscope;
determining, from the received sensor data: linear acceleration data from the accelerometer or angular velocity data from the gyroscope; and
calculating position updates of the device based on the linear acceleration data and/or the angular velocity data.

19. The method of claim 17, wherein tracking the location of the device of the user comprises:
receiving sensor data from a plurality of sensors of the device, wherein the plurality of sensors comprise an accelerometer, a gyroscope, and a magnetometer; and
performing pedestrian dead reckoning by:
determining step detection and step length from the accelerometer data, determining orientation changes from the gyroscope data,
determining heading information from the magnetometer data, and
calculating position updates of the device using a sensor fusion approach that combines the step detection, step length, orientation changes, and/or heading information.
